(19) United States
(12) Patent Application Publication
(10) Pub. No.: US 2007/0023958 A1
(43) Pub. Date: Feb. 1, 2007

(54) Polyester fiber scrim and method for making same

(76) Inventors: Daniel LaVietes, Dallas, TX (US); Darrell Heine, Red Oak, TX (US); Kevin J. Bush, Waxahachie, TX (US)

Correspondence Address: BAKER & BOTTS L.L.P., 30 ROCKEFELLER PLAZA, 44TH FLOOR, NEW YORK, NY, 10112-4498, US

(21) Appl. No.: 11/541,329

(22) Filed: Sep. 29, 2006

Related U.S. Application Data
(62) Division of application No. 11/288,860, filed on Nov. 29, 2005.
(60) Provisional application No. 60/693,659, filed on Jun. 24, 2005.

(51) Int. Cl. B29C 70/30

(52) U.S. Cl. 264/257

(57) ABSTRACT

Self-supporting scrim or web structure, which is readily thermopleated, is provided for use in filter applications. The self-supporting scrim has very high porosity. When pleated and deployed for filter applications, the scrim or web structure retains the shape of pleats and contributes minimally to airflow resistance. The scrim or web structure is fabricated from synthetic fibers and latex binders using a wet laid process.

### CROSS REFERENCE TO RELATED APPLICATION

The present application is a divisional of U.S. patent application Ser. No. 11/288,860 filed Nov. 29, 2005, claiming priority from U.S. Provisional Patent Application No. 60/693,659 filed Jun. 24, 2005, both of which applications are incorporated by reference herein in their entireties.

### FIELD OF THE INVENTION

The present invention relates to filters, filter constructions, materials for use in filter constructions and methods of filtering. The present invention in particular relates to construction materials utilized for supporting one or more layers of fine fibers in filter media.

### BACKGROUND OF THE INVENTION

Air filtration media used in application such as High Efficiency Particulate Air (HEPA) or Ultra Low Particulate Air (ULPA) filters require the use of very fine diameter fibers. These fibers can be formed from synthetic polymers, such as polyethylene, polypropylene and polyester or from glass microfibers.

Webs or layers of these very fine diameter fibers are extremely fragile and must have some means of support when pleated and placed in the frame or cylindrical structure of the filter. Traditionally, wire screen and plastic netting are used as media supports. These supports may be acceptable for, glass microfiber webs, which contain very low percentages of synthetic latex binders providing limited strength for processing.

Melt blown and nanofiber webs and layers are pure polymers, which must be blown directly on to a blanket or carrier web. Synthetic scrims are used as these blankets. The use of a scrim having low porosity results in increased airflow resistance of the filter media, which is undesirable. Higher porosity can be achieved by reducing the basis weight of the scrim, but then its ability to be self-supporting is correspondingly diminished.

Consideration is now being given improving the structural characteristics and other properties of scrims, and to methods for making such scrims. A scrim, which is designed for applications such as filters, may have the following desirable characteristics: (a) a sufficient basis weight to be self-supporting when pleated; (b) the ability to hold the shape of the pleats; and, (c) very high porosity (i.e., minimal, if any contribution to air flow resistance).

### SUMMARY OF THE INVENTION

A self-supporting scrim or web structure is provided for use in filter applications. The self-supporting scrim has very high porosity. When pleated and deployed for filter applications, the scrim or web structure retains the shape of pleats and contributes minimally to airflow resistance.

An inventive wet-laid process with wet-web saturation is used for making the scrim or web structure. The wet-laid process parameters are controlled so that the wet-laid web has greater uniformity than webs formed by other processes, for example, spun bond webs or dry-laid webs. Control of blending of fibers of different thickness can be both costly and difficult in spun bond processes. In contrast, the inventive wet-laid process allows blending of fibers of different thickness and lengths.

Synthetic fibers of one or more polymer types and a latex binder (e.g. a thermoplastic binder) of a different polymer type may be used in the make the scrim or web structure. The scrim or web structure is thermally softened so that it can be shaped (e.g. pleated, corrugated) as desired for filter applications. The synthetic fibers and the latex or thermoplastic binding polymers in the scrim or web structure are selected to have different softening or melting points. The latex or thermoplastic binder is selected to soften or melt at relatively low temperatures so that the scrim or web structure can be shaped without damaging its fiber structure or losing its physical properties.

The inventive scrims and web structures are readily thermopleated in comparison to conventional nylon fiber based scrims. The polyester fibers and acrylic polymer latexes are much less expensive than nylon fibers. Further, the inventive wet-laid scrims or web structures can have considerably higher porosity that conventional nylon continuous filament webs. Additionally, the wet-laid scrims or web structures have higher permeability at equal basis weight than conventional spun bonded polyester scrims.

### DESCRIPTION OF THE INVENTION

Scrims are provided for filter applications. The scrims are self-supporting when pleated or corrugated. The scrims are fabricated suitable material compositions, which allow the scrim to hold the shape of the pleats and retain high porosity characteristics. Further, wet-laid processes for web forming such scrims with the suitable material compositions are provided. These wet-laid processes of web forming provide greater uniformity than spun-bond webs and dry-laid webs. Advantageously, the wet-laid processes for scrim fabrication are more economical than conventional fabrication processes at least in part due to enhanced production speeds at which scrims can be formed by a wet-laid process.

The inventive wet-laid process allows fabrication of scrims composed of blends of fibers of different thicknesses and lengths, which are costly and difficult to control in conventional processes such as spun bond processes.

The wet-laid process with wet-web saturation allows the use of synthetic fibers of one or more polymer type and a latex binder of a different polymer type. In most instances, the softening or melting points of the fibers and polymer types are selected to be different. In preferable compositions, the latex binder is a thermoplastic binder that can be softened without damaging the fiber structure. Webs fabricated using such latex binders can be shaped (e.g., pleated or corrugated) while maintaining or retaining their desirable physical properties.

Such shaping properties are particularly remarkable when compared to spun bond polypropylene webs, since the entire structure softens and melts at relatively low temperatures.

High porosity is very important in fabrics used as scrims, supports or carrier webs. The inventive scrims may advantageously have considerably higher porosity that prior art fabrics or scrims. (See e.g., nylon continuous filament webs available from Cerex).

The inventive scrims may have permeability values, which are significantly higher than those of conventional spun bonded polyester scrims of equal basis weight (e.g. such as scrims available from Reemay).

The materials used for fabrication of the scrims (e.g. polyester fibers and acrylic polymer latexes) can be substantially less expensive than nylon fibers, whose use in scrims has been previously suggested. Nylon fibers are an “overkill” for most scrim applications (except, for example, for very high temperature applications). Further, nylon fibers are not readily thermo-pleated.

The methods and compositions of the present invention may be better understood or appreciated through the working Examples detailed below. These Examples are presented for purposes of illustration and should not be construed as limiting the invention in any way.

### EXAMPLE I

A fiber furnish composed of 90% 6 denier ½″ length Type 103 polyester fiber and 10% 15 denier 1½″ Type 103 polyester fiber, both supplied by KoSa, were dispersed in a pulper, along with minor amounts of dispersant and viscosity modifier, commonly used in wet-laid mat manufacturing.

A web was formed on a Deltaformer® (Sandy Hill Corporation) and wet-web saturated with Rhoplex® GL-618 Acrylic Latex (Rohm and Haas Company) to a binder level of 25% of the total weight of the scrim and the web dried using conventional gas-fired ovens. The basis weight of the dried scrim was 2.4 oz/yd² (81 g/m²).

### EXAMPLES II TO IV

Scrims having basis weights of 2.0 oz/yd² (68 g/m²), 1.8 oz/yd² (61 g/m²) and 1.6 oz/yd² (54 g/m²) were prepared in Examples II, III, and IV, respectively. The method of preparation used in each instance was similar to that used in Example I described above.

Properties of the samples of the scrims prepared in Examples I-IV were characterized using standardized physical tests. Table I shows several of the measured properties (i.e., basis weight, thickness, and Frazier porosity of these samples. Table I also references the corresponding standard test methods that were used to measure the individual properties.

TABLE I
PHYSICAL PROPERTIES OF EXAMPLE I-IV SCRIMS

| Property | Reference | Ex. I | Ex. II | Ex. III | Ex. IV |
|---|---|---|---|---|---|
| Basis Weight (oz/yd²) | Tappi T-410 | 2.4 | 2.0 | 1.8 | 1.6 |
| Thickness (mil) | Tappi T-411 | 26 | 24 | 22 | 21 |
| Frazier Porosity | ASTM D-737 | 750 | 863 | 901 | 970 |
| (cfm/ft²) | | | | | |

It will be understood that the foregoing examples are only illustrative of the principles of the invention, and that various modifications can be made by those skilled in the art without departing from the scope and spirit of the invention. This invention provides a wet-laid, high porosity, thermopleatable synthetic scrim, composed of polyester fibers and a thermoplastic synthetic latex binder.

In exemplary scrims, polyester fibers may constitute 65% to 85% of the weight of the scrim. The polyester fibers may have a thickness range of 6 denier (equivalent to 25 microns) to 15 denier (equivalent to 39 microns) and a cut length range of 0.5 inch to 1.5 inches. The synthetic latex binder material, which may constitute 15% to 35% of the weight of the scrim, may be a thermoplastic acrylic resin. A suitable acrylic resin has a softening point between 200° F. and 300° F.

The basis weight of the exemplary scrims may be in the range of 1.4 oz/yd² (47 g/m²) to 2.6 oz/yd² (88 g/m²) and have a Frazier porosity in the range of 700 to 1050 cfm/ft².

A particular scrim made from a polyester fiber and acrylic resin binder has a tensile strength of about 62 lbs/3″ width, an elongation of about 10%, and Elmendorf tear value of about 972 grams.

The inventive scrims are suitable for use in filtering structures. In one such structure, a dual layer filtration media formed by the application of melt-blown polypropylene fibers to one surface of the inventive scrim. Further, combining an additional scrim layer with the dual layer media may form a triple layer filtration media. The additional scrim layer may be of any type including convention scrim types. Alternatively, a dual layer filtration media may be formed by combining a glass microfiber mat with a scrim of the present invention. A further layer of any type of scrim may be disposed on the open face of glass microfiber layer to form a three layer filtration media.

In another application, a dual layer filtration media is formed by the application of polypropylene nanofibers to one surface of a scrim of the present invention. A further layer of any type of scrim may be disposed on the open face of polypropylene nanofiber layer to form a three layer filtration media.

The dual and triple-layer self-supporting scrims may be mechanically and thermally pleated in suitable geometrical configurations for use as filter elements. In one example, a dual layer media is first mechanically pleated to form a pleated filtration media element. The pleat tips are then pushed or moved through a channel formed by top and bottom platens, which are heated to about 250° F. to 300° F. This heating softens the synthetic binder in the mechanically pleated scrim, which then retains the geometry of the pleats upon cooling. In another example, a three layer media including the inventive scrim layer is first mechanically pleated and then its pleat tips are pushed through a channel of top and bottom heated platens. Again heating the platens to about 250° F. to about 300° F. can soften the synthetic binder of the scrim, which then retains the geometry of the pleats upon cooling.

The self-supporting scrims used in the two layer and three layer media elements may include a blend of polyester fibers of different thicknesses and cut lengths. In one exemplary scrim, the polyester fibers are a blend of 6 denier ½ and 15 denier 1½ polyester fibers. In a particular scrim fabrications, the amounts of 6 denier to 15 denier polyester fibers may be selected to have a ratio of about 4:1 to about 19:1. In a preferred selection, the ratio may be from about 6:1 to about 12:1. A ratio of 9:1 of 6 denier to 15 denier polyester fibers may be most suitable.

The self-supporting scrims fabricated from synthetic latex binder using the inventive wet-laid processes may have basis weight in the range of 1.4 oz/yd² (47 g/m²) to 2.6 oz/yd² (88 g/m²), or preferably in the range of 1.6 oz/yd² (54 g/m²) to 2.4 oz/yd² (81 g/m²).

The synthetic latex binder used in the inventive scrim compositions may, for example, be a thermoplastic acrylic resin with a softening point between 200° F. and 300° F. The latex binder may constitute 15% to 35% of the weight of the scrim. Preferably 20% to 30% of the weight of the scrim, and most preferably 25% of the weight of the scrim.

The inventive scrim may be characterized as having Frazier porosity in the range of 700 to 1050 cfm/ft² or preferably in the range of 750 to 970 cfm/ft².

The inventive wet laid scrim or web structure (hereinafter “Scrim”) may be utilized in filter constructions in any suitable configuration or combination with other filter materials or components (e.g., melt blown polypropylene fibers, glass microfiber mat and polypropylene nanofibers). The Scrim may, for example, be configured as a layer in a dual or multiple layer filter media.

In one exemplary filter construction, a dual layer filtration media is formed by the application of melt blown polypropylene fibers to one surface of the Scrim. Further, a three-layer filtration media is formed by sandwiching a layer of melt blown polypropylene fibers between the Scrim and another scrim. The latter scrim may be of any type. Similarly, in another exemplary filter construction, a dual layer filtration media is formed by combining a glass microfiber mat with the Scrim. Further, a three layer filtration media is formed by sandwiching a layer of a glass microfiber mat between the Scrim and another scrim that may be of any type. In yet another exemplary filter construction, similar dual or three-layer filtration media are obtained by replacing the glass microfiber mat or melt blown polypropylene layer by polypropylene nanofibers.

The dual or multilayer media having the self-supporting Scrim may be mechanically shaped or pleated in the shape of the desired filter element. Portions of the mechanically shaped scrim then may be heated and cooled to form a self-supporting structure that preserves or retains the shape of the desired filter element. In an exemplary implementation of a “pleat retention” process, the pleated media is pushed through a channel composed of two platens. One or both platens are heated to 250° F. to 300° F. to soften the thermoplastic latex binder of the Scrim at the pleat tips. Upon exiting the channel and cooling, the pleats retain their shape.

It will be understood that the foregoing is only illustrative of the principles of the invention and that various modifications can be made by those skilled in the art without departing from the scope and spirit of the invention, which is limited only by the claims that follow.

1. A method for making a shaped filter media element that is self supporting, the method comprising:
obtaining a scrim comprising polyester fibers and a synthetic latex binder, wherein the latex binder has a softening temperature lower than the softening temperatures of the polyester fibers;
mechanically shaping the scrim to a desired shape; and
thermoplastically setting the mechanically shaped scrim to retain the desired shape

2. The method of claim 1, wherein obtaining a scrim comprising polyester fibers and a synthetic latex binder, comprises making the scrim by a wet-laid process.

3. The method of claim 1, wherein mechanically shaping the scrim to a desired shape comprises mechanically pleating the scrim.

4. The method of claim 1, wherein thermoplastically setting the scrim in the desired shape comprises heating at least a pleat tip of the mechanically pleated scrim to a temperature of between about 200° F. and about 300° F.

5. The method of claim 1, wherein thermoplastically setting the scrim in the desired shape comprises heating at least a portion of the mechanically shaped scrim to the softening temperature of the latex binder.
